(19) United States
(12) Patent Application Publication
(10) Pub. No.: US 2008/0259337 A1
(43) Pub. Date: Oct. 23, 2008

(54) BIOLOGICAL OPTICAL MEASURING APPARATUS AND LIGHT DETECTION MODULE

(76) Inventors: Kazuhiko SAGARA, Kodaira (JP); Yukio Kumagai, Tokorozawa (JP); Naoki Matsushima, Yokohama (JP); Masashi Kiguchi, Kawagoe (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/944,064

(22) Filed: Nov. 21, 2007

(30) Foreign Application Priority Data
Jan. 16, 2007 (JP) 2007-006524

(51) Int. Cl. G01N 21/00

(52) U.S. Cl. 356/432; 250/239

(57) ABSTRACT

A cerebral function measuring apparatus houses a light detector in a package that can be set on the head of the subject examinee with light detection elements, amplifiers, and high voltage power supplies sealed in the package. Each amplifier and each high voltage power supply are united into one and covered with a high polymer material with high dielectric strength, and further enclosed by a metallic shield so as to be insulated. The high voltage power supply consists of a very small coil and an integrated circuit to generate a voltage required to drive the light detection element in the package. A removable and safe module type light detector is thus realized.

### CLAIM OF PRIORITY

The present application claims priority from Japanese application JP 2007-006524 filed on Jan. 16, 2007, the content of which is hereby incorporated by reference into this application.

### FIELD OF THE INVENTION

The present invention relates to a biological optical measuring apparatus that checks the internal state of a living body with use of a light, more particularly to a compact module type light detection apparatus excellent in portability and capable of measuring the cerebral function of a subject examinee by analyzing the intensity of a light transmitted through the head of the examinee.

### BACKGROUND OF THE INVENTION

As means for measuring the human's cerebral function, there is a well known topography technique. The technique irradiates a near-infrared light to part of the head of the subject examinee, analyzes the intensity of the reflected light, and displays the distribution of blood kinetics in the cerebral cortex two-dimensionally. This light topography apparatus includes a light source, a detector, and a signal processor. A probe is fixed at the subject human's head and the probe is connected to the apparatus through plural optical fibers for measuring the distribution of blood kinetics in the brain. This method clarifies the correspondence between the human's motor function and the respective brain's localized regions, thereby providing new clues of mental and medical treatments. In recent years, this localized cerebral function is used to develop interface techniques for controlling external units and devices such as computers, games, environmental control units, etc., by utilizing signals measured from the brain. JP-A No. 07 (1995)-314195 proposes a method for facilitating such a development. According to the method, a biological optical measuring apparatus is used to measure the intensity of a light transmitted through the head of the subject examinee to compute an amount of oxidized and reduced hemoglobin with use of a computing device, thereby driving an object external device according to the computed data. On the other hand, JP-A No. 10 (1998)-346450 proposes a method for determining a history of changes of measured signals obtained from a biological optical measuring apparatus with use of a computing device, a storage device, a controller, etc. and applies the determination result to certain rules, thereby making switching among TV channels. JP-A No. 2000-373292 also proposes an interface technique for controlling an object on a screen according to the intensity of a light signal obtained by setting a light irradiator and a light detector on the skin of the subject examinee.

Those techniques provide welfare information units and devices for mainly supporting bedridden patients, as well as interface techniques applied to information home electric appliances that are different from conventional ones.

### SUMMARY OF THE INVENTION

However, in any of the above described conventional techniques, each of the cerebral function measuring apparatuses is complicated in configuration and large in scale, so that they are difficult to be carried. This has been a problem. Particularly, the light irradiator and the light detector are manufactured with a state-of-the-art semiconductor technology, so that its effect of mass production has not been expected. In addition, the light irradiator and the light detector are limited in operating life and services must stop during their parts exchanges. Furthermore, in any of the conventional biological optical measuring apparatuses, the cerebral function measuring unit and the head probe are connected to each other through plural optical fibers, so that it has been difficult to increase those optical fibers to increase measuring spots, since a long time measurement is often refused by the examinee due to the weight of those optical fibers. The distance between the measuring apparatus and the examinee's body is also limited by the lengths of the optical fibers, so that measurement of the cerebral function is impossible while the examinee is walking or in motion.

Under such circumstances, it is an object of the present invention to provide a structure of a removable module type light detector to realize a compact and portable biological optical measuring apparatus. It is another object of the present invention to provide a structure of an easy-to-handle and safe shield type light detector to achieve the same.

In order to achieve the above objects, the light detector of the present invention is housed in a package having a size for enabling the light detector to be easily put on the examinee's head and a light detection element, an amplifier, and a high voltage power supply thereof are shielded in the package. And the amplifier and the high voltage power supply are united into one and covered with a high insulation high polymer material and enclosed again by a metal shield material, thereby insulating the package from external. The high voltage power supply is composed of a very compact coil and an integrated circuit, thereby generating a voltage required to drive the light detection element in the package. As a result, a removable and safety module type light detector has been realized. The high polymer with a high insulation property is just required to satisfy a condition that those elements are electrically insulated from each another. In this case, the high polymer material means a material having a volume resistivity of 1 teraohmmeter or over and an electrical breakdown voltage of 10 kV or over. For example, it may be any of resin, silicon rubber, etc.

Concretely, the present invention provides a biological optical measuring apparatus that includes a light irradiation module for irradiating a light to an examinee; a light detection module for detecting the light irradiated from the light irradiation module and transmitted through the examinee; and a computing device for computing blood kinetics of the brain of the examinee from a detection result of the light detection module. The light detection module includes a first circuit substrate having a high voltage power supply, a second circuit substrate having a signal amplification circuit, and a light detection element for detecting the light. The first and second circuit substrates and the light detection element are disposed in three dimensions in the light detection module in the order of the first circuit substrate, the second circuit substrate, and the light detection element or in the order of the second circuit substrate, the first circuit substrate, and the light detection element. The first and second circuit substrates are enclosed by a housing material and the housing material has a hole for guiding the light irradiated from the light irradiation module and transmitted through the examinee to the light detection element.

Outside the housing material is exposed a power supply terminal and another terminal for guiding signals detected by the light detection element to external.

According to an embodiment of the present invention, the portability is therefore improved because the light detection module can be set on the examinee's head. Because a high voltage generated in the module is shielded so as not to be leaked to external, the safety is excellent. Furthermore, the light detection module can be replaced in units of a module, the maintenance cost is reduced and the reliability is improved.

### BRIEF DESCRIPTION OF THE DRAWINGS

FIG. 1 is an explanatory drawing for showing a system configuration in a first embodiment of the present invention;

FIG. 2 is a configuration of the probe shown in FIG. 1;

FIG. 3 is a cross sectional view of the configuration of the detector shown in FIG. 1;

FIG. 4 is a block diagram for showing a structure of the detector shown in FIG. 1;

FIG. 5 is another block diagram for showing the structure of the detector shown in FIG. 1;

FIG. 6 is a cross sectional view for showing the configuration of the detector shown in FIG. 1;

FIG. 7 is another cross sectional view for showing the configuration of the detector shown in FIG. 1;

FIG. 8 is still another cross sectional view for showing the configuration of the detector shown in FIG. 1;

FIG. 9 is a cross sectional view for showing disposition of the electrodes of the detector shown in FIG. 1;

FIG. 10 is another cross sectional view for showing disposition of the electrodes of the detector shown in FIG. 1;

FIG. 11 is still another cross sectional view for showing disposition of the electrodes of the detector shown in FIG. 1;

FIG. 12 is still another cross sectional view for showing disposition of the electrodes of the detector shown in FIG. 1;

FIG. 13 is a block diagram for showing a circuit of the detector shown in FIG. 1;

FIG. 14 is a system configuration diagram in a second embodiment of the present invention; and

FIG. 15 is a system configuration diagram in a third embodiment of the present invention.

### DETAILED DESCRIPTION OF THE PREFERRED EMBODIMENTS

Hereunder, the preferred embodiments of the present invention will be described with reference to the accompanying drawings. In those drawings, the same reference numerals will be used for the same components, avoiding redundant description.

### First Embodiment

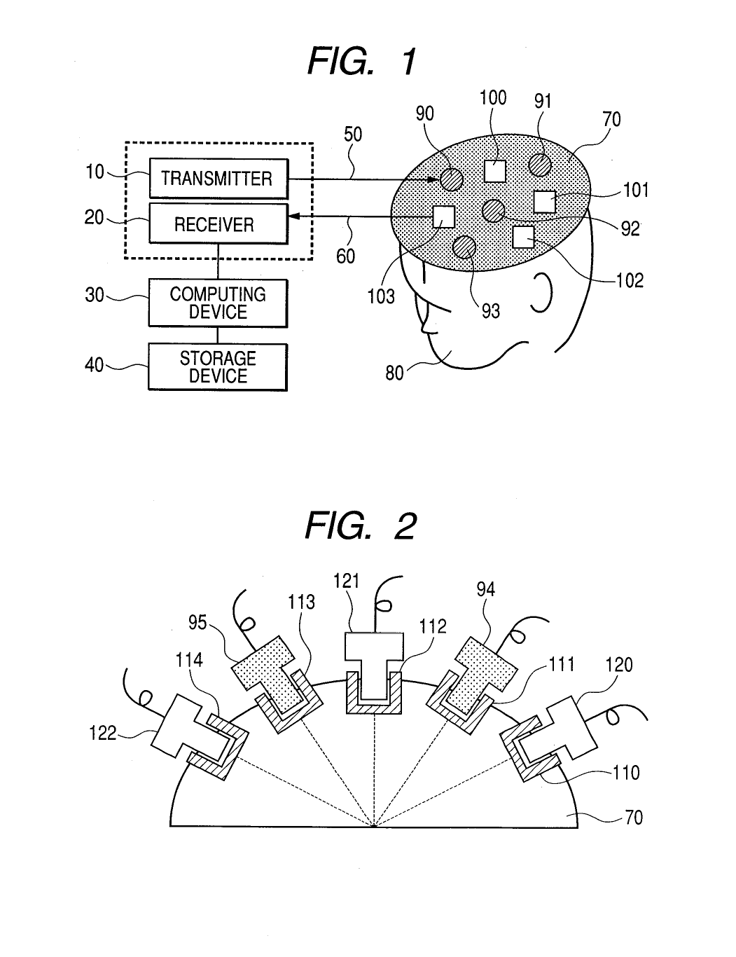

FIG. 1 shows an explanatory drawing of how the present invention applies to a biological optical measuring apparatus. A probe 70 is set on the head of an examinee 80 to measure the state of blood kinetics. The probe 70 includes plural light sources 9n and plural detectors 10n. Those light sources 9n and detectors 10n are connected to a measuring apparatus installed separately from the examinee 80 through a send cable 50 and a receive cable 60. The measuring apparatus consists of a transmitter 10, a receiver 20, a computing device 30, and a storage device 40. The transmitter 10 sends electrical signals converted to those having a specific frequency or light signals converted to those having a wavelength of a near-infrared region respectively to the plurality of light sources 9n. Each of the detectors 10n detects a light scattered on the surface of the cerebral cortex and converts the detected light to an electrical signal to be sent to the receiver 20. The receiver 20 processes information exchanged between the computing device 30 and the storage device 40 to compute an amount of hemoglobin in the brain from the electrical signal. Thus changes of the blood amount in the cerebral cortex can be displayed in a two-dimensional space.

FIG. 2 shows a cross sectional view of the probe 70, as well as the plurality of light sources 9n and the plurality of detectors 10n disposed on the probe 70 shown in FIG. 1. The probe 70 includes plural sockets 11n disposed regularly. Each light source 9n or detector 10n is inserted in one of the sockets 11n. Each light source 9n or detector 10n is structured as a module and this module is inserted/removed in/from its socket 11n, thereby realizing arrangement of a variety of detection patterns. And when a light source 9n or detector 12n goes wrong, it is easily replaced with a normal one.

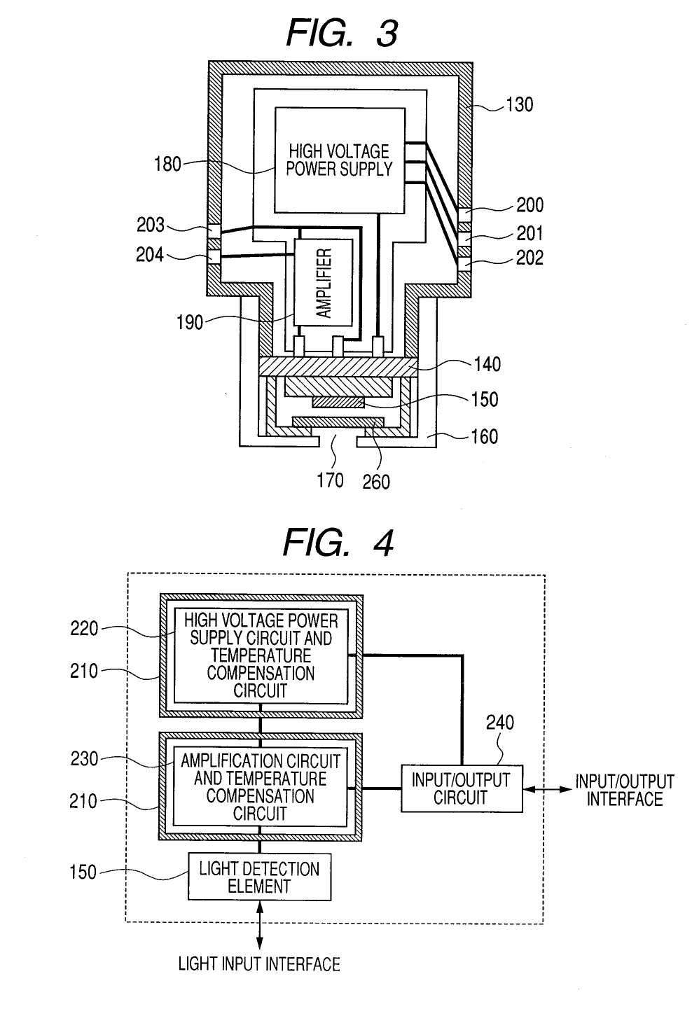

FIG. 3 shows a cross sectional view of a configuration of a detector 10n of the present invention. The detector 10n consists of a light detection element 150, a high voltage power supply 180, and an amplifier 190 housed in a package. Those components are covered by a case 130 and then by a high polymer material 160 with higher electric insulation. Plural electrodes 20n for sending/receiving signals to/from the high voltage power supply 180, the amplifier 190, and external are disposed on the surface of the case 130. Under the high polymer material 160 with high electric insulation is provided an aperture 170 for guiding an external light. The aperture 170 has a filter 260 at its inlet to remove unnecessary wavelengths. The use of this filter 260 depends on the ambient conditions; it is not necessarily required. In FIG. 3, the high voltage power supply 180 is disposed in the upper portion while the amplifier 190 is disposed in the lower portion. However, their disposition places can be inverted up and down with no problem.

FIG. 4 shows a block diagram for showing a structure of the detector 10n. The detector 10n consists of a light detection element 150, a module of a high voltage power supply circuit and a temperature compensation circuit 220, and a module of an amplification circuit and a temperature compensation circuit 230. The high voltage power supply circuit generates a voltage of around 200V, so that it must be insulated from external. This is why the present invention encloses the module 220 and the module 230 with a shield 210 respectively. Consequently, the safety is more improved even when handing a module of the detector 10n manually. In addition, because the magnetic waves are prevented from leaking to external, influences of the magnetic waves to human bodies are reduced.

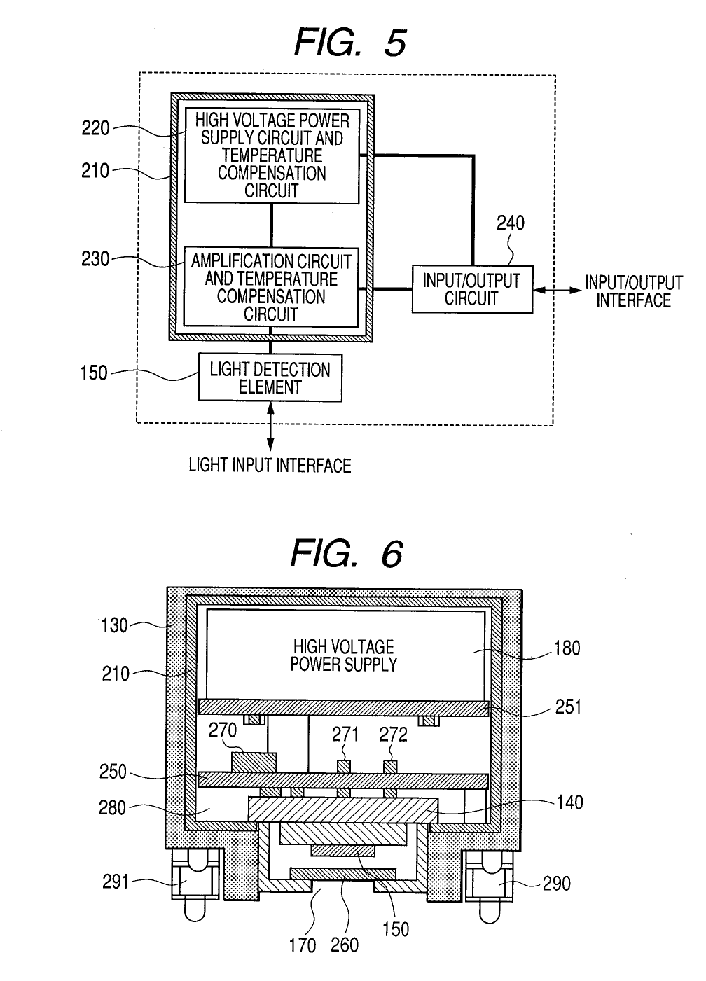

FIG. 5 shows an example in which the modules 220 and 230 are enclosed by one shield 210. Also in this case, it is possible to obtain the same effect as that shown in FIG. 4.

FIG. 6 shows a cross sectional view of a structure of the detector 10n shown in FIG. 1. The detector 10n consists of a light detection element 150 housed in a package 140, an amplification circuit 27n disposed on a printed-circuit board 250, and a high voltage power supply 180 disposed on a printed-circuit board 251. Those boards 250 and 251 and circuits 27n are made of high electric insulation silicon or the like respectively. The detector 10n is covered entirely by a metallic shield 210. This module of the detector 10n is sealed in a case 130 made of a high insulation polymer material. Under this case 130 is provided an aperture 170 for guiding an external light. And the aperture 170 has a filter for eliminating unnecessary lights. Around the bottom of the case 130 is disposed plural electrodes 29n, each having a spring in itself. This secures the electrical connections of those electrodes 29n inserted respectively in the sockets 11n shown in FIG. 2. In this example, the electrode 290 is connected to the printed-circuit board 250 in the metallic shield 210 and the electrode 291 is connected to the case 130. Consequently, a dielectric strength test can be carried out by applying a voltage between the electrodes 290 and 291.

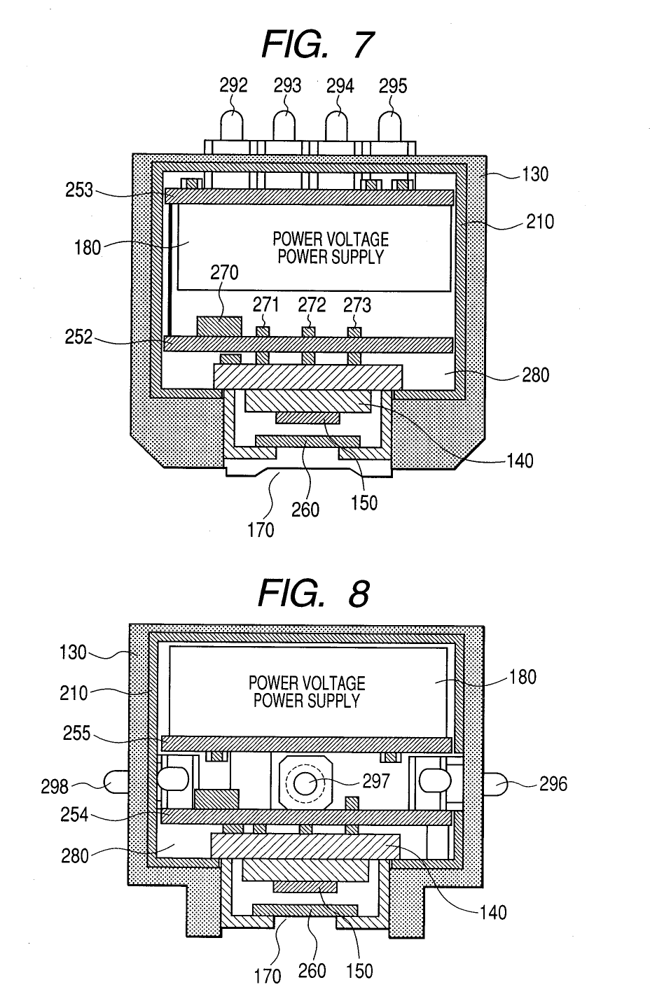

FIG. 7 shows an example in which the electrodes 29n shown in FIG. 6 are disposed on the top surface of the case 130. In this example, the high voltage power supply 180 is disposed under the board 250 and the boards 250 and 251 are connected to each other by a wire. The high voltage power supply 180 and the amplification circuit 27n are covered by a metallic shield 210 and furthermore, all the detectors 10n are housed in the case 130. Consequently, the detectors 10n are insulated perfectly to assure the safety when in handing the detectors 10n. In addition, this structure is not connected to any of the sockets 11n and the case 130 mechanically and electrically, the structure never affects the electrical signals even when the positional relationship between the sockets 11n and the detectors 10n is varied. This is a merit of the structure.

FIG. 8 shows an example in which the plural electrodes 29n shown in FIG. 6 are disposed at the periphery of the case 130. In this example, a counter electrode is also disposed at the side face of each socket 11n. And because this counter electrode and a spring electrode 296 come in contact with each other at a certain elastic force, the electrical connection between them is assured. The same effect can also be obtained by using a spring electrode at the counter electrode side and a fixed electrode at the side of the case 130.

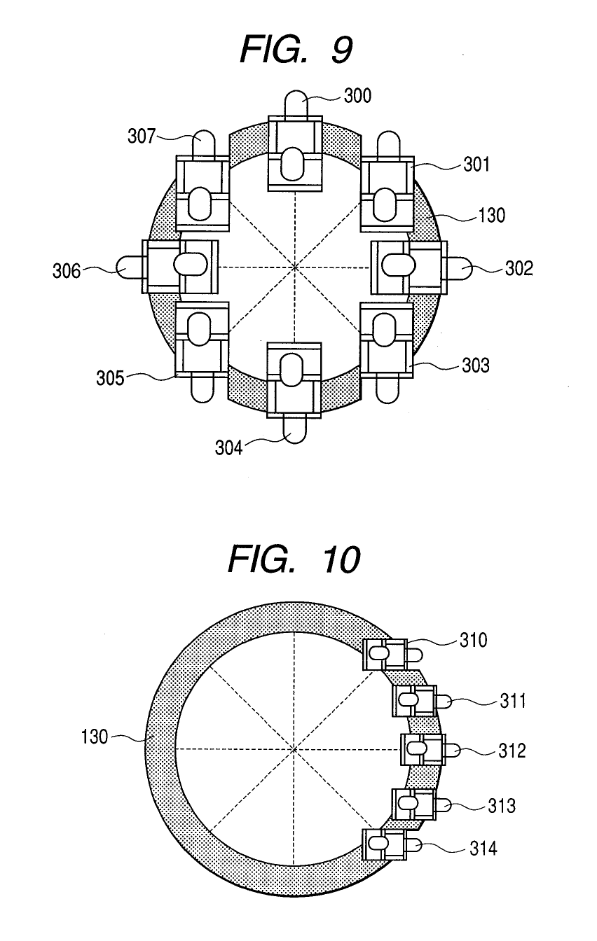

FIG. 9 shows a cross sectional view of the structure shown in FIG. 8. In this example, the plural electrodes 30n are disposed at equal intervals in a concentric circle pattern. Consequently, the distance between each socket 11n and the case 130 can be kept constantly. If the number of electrodes 30n is less, the electrodes 30n may be disposed at one side of the case 130.

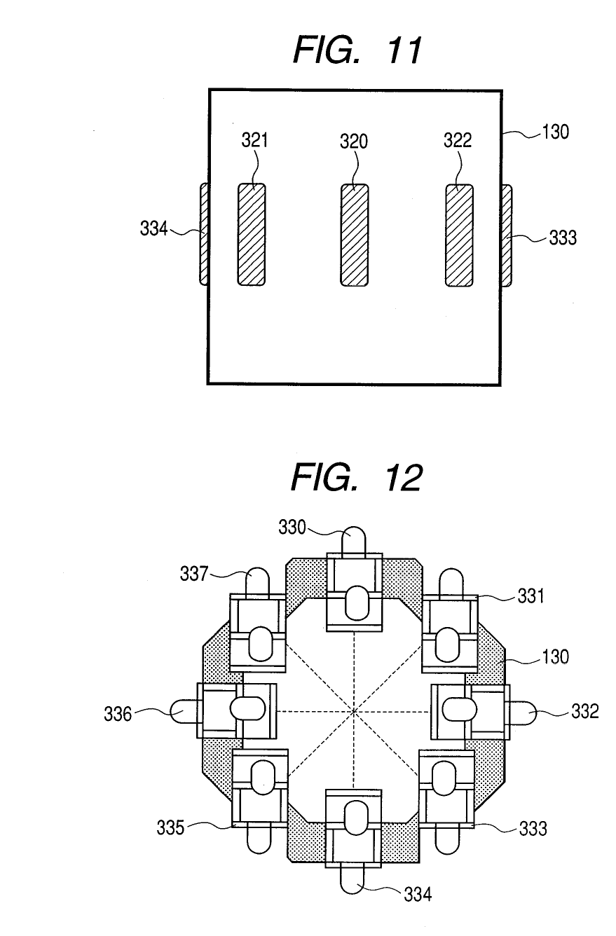

FIG. 11 shows an example in which the shape of the electrodes 29n shown in FIG. 8 is varied. In FIG. 11, the shape of the electrodes 32n is rectangular. Consequently, the rectangular detectors 10n are inserted in the sockets 11n, thereby the electrical connection between them is assured even when the positional relationship between the detectors 10n and the sockets 11n is shifted slightly up and down. Thus the user can use the apparatus more easily.

FIG. 12 shows an example in which the cross sectional shape of the case 1300 shown in FIG. 9 is polygonal. In this example, the case 130 is octagonal. The electrodes 33n are disposed at the eight sides of the octagon respectively. Consequently, the detectors 10n having such a shape can be inserted in the sockets 11n so as to prevent each detector 10n from shifting in the rotating direction, thereby the electrical connection between each of the detectors 10n and each of the sockets 11n can be stabilized.

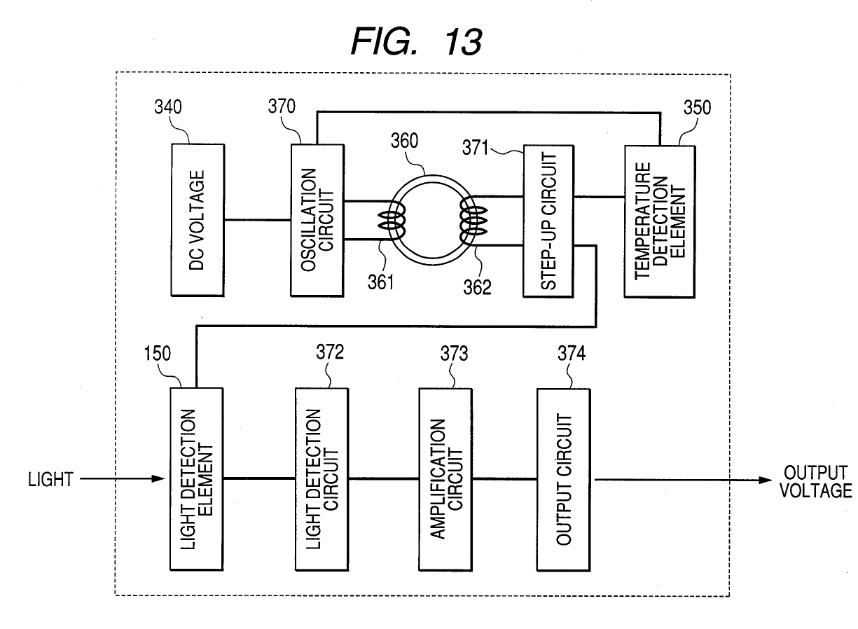

FIG. 13 shows a block diagram for showing a circuit of the detector 10n shown in FIG. 1. A light detector 150 catches incident signals and converts the signals to electrical signals. A light detection circuit 372 detects a weak current and an amplification circuit 373 amplifies the current. Then, an output circuit changes the current to a voltage to be assumed as an external voltage. The light detection element 150 is supplied a high driving voltage from a step-up circuit 371. A coil 360 generates this high voltage. At first, a DC voltage 340 is applied to an oscillation circuit 370 to generate a pulse voltage. This pulse voltage is applied to the primary side 361 of the coil 360 to generate an AC voltage higher than the pulse voltage at the secondary side 362 of the coil 360. This AC voltage is applied to the step-up circuit 371 to generate a driving high supply voltage. The temperature detection element 350 is connected to the step-up circuit 317 and the detected signal is fed back to the oscillation circuit 370. Consequently, a stable supply voltage is realized.

### Second Embodiment

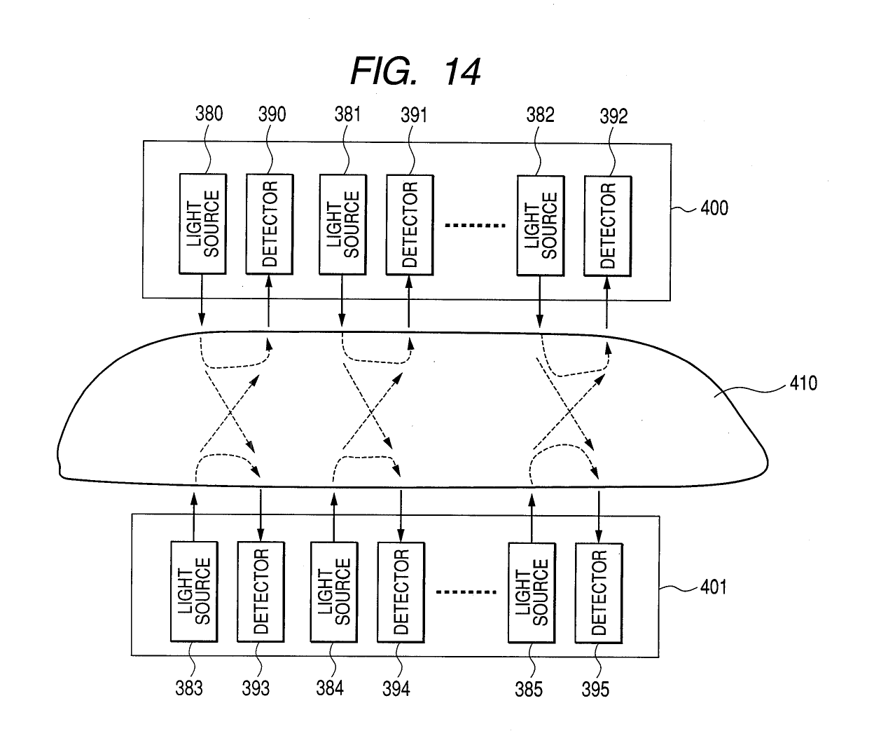

FIG. 14 shows a second embodiment of the present invention. Each of measuring systems 400 and 401 includes plural light sources 38n and plural detectors 39n that are disposed at equal intervals in an array pattern. Each detector 39n is structured as a module according to the present invention to improve the portability. The use of one unit of this measuring system 400 enables measurement of the freshness, etc. of food, since the light irradiated from a light source 380 is reflected at the surface of the subject living sample 410 and caught by the detector 390. If two units of this measuring system 400 are used to measure a living sample set therebetween, for example, the light irradiated from a light source is caught by the detectors 393, so that the distribution of the water contained in any of the examinee's organs can be measured.

### Third Embodiment

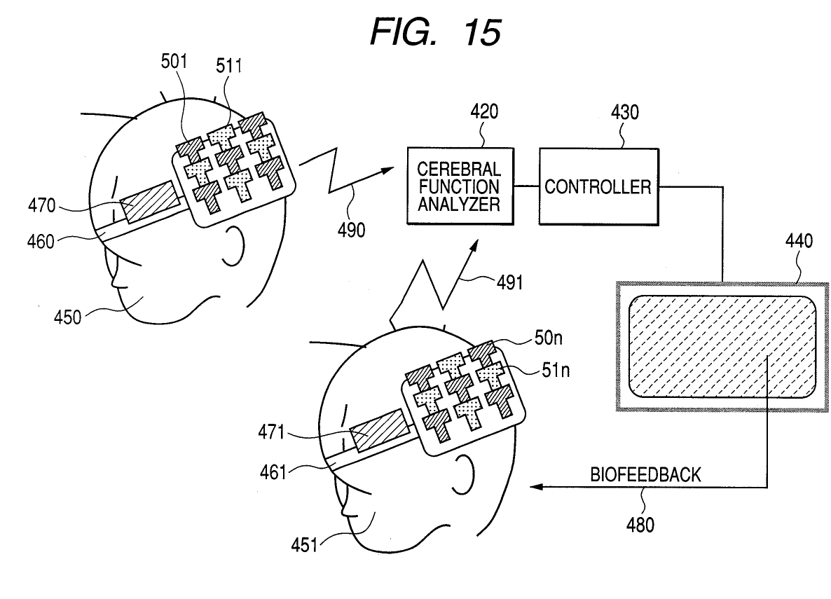

FIG. 15 shows a third embodiment of the present invention. In this example, a module type detector is used for part of a head band. A human body 45n puts on a band 46n wound around his/her head to measure blood kinetic changes in the brain. The band 46n includes a measuring system 40n and a transmitter 47n. The measuring system includes plural light sources 50n and plural detectors 51n. The transmitter 470 exchanges measured signals with an external cerebral function analyzer 420 wirelessly 49n. The cerebral function analyzer 420 is connected to a controller 430 and generates a signal in accordance with changes of blood kinetics. This signal is used to control the operations of the cursor and animations displayed, for example, on a display screen 440. Each of two players who control the changes of blood kinetics in his/her brain, moves a character on the screen to play, for example, a combat game. The players can also observe character movements on the screen to obtain visual biofeedback 480 respectively, thereby controlling the character movements more accurately.

What is claimed is:

1. A biological optical measuring apparatus, comprising:
a light irradiation module for irradiating a light on an examinee;
a light detection module for detecting said light irradiated from said light irradiation module and transmitted through said examinee; and
a computing device for computing blood kinetics of the brain of said examinee from a detection result of said light detection module,
wherein said light detection module includes:
a first circuit having a high voltage power supply;
a second circuit having a signal amplifying circuit; and
a light detection element for detecting a light,
wherein said first and second circuits and said light detection element are disposed in three dimensions in the order of said first circuit, said second circuit, and said light detection element or in the order of a second circuit board, a first circuit board, and said light detection element,
wherein said first and second circuits are enclosed in a housing material,
wherein said housing material has a hole for guiding a light irradiated from said light irradiation module and transmitted through said examinee to said light detection element, and
wherein a terminal for supplying a power and a terminal for guiding a signal detected by said light detection element to external are exposed outside said housing material.

2. The biological optical measuring apparatus according to claim 1,
wherein a test terminal for measuring an insulating strength is exposed outside said housing material.

3. The biological optical measuring apparatus according to claim 1,
wherein said apparatus further includes a controller for controlling an external device according to a computation result of said computing device.

4. The biological optical measuring apparatus according to claim 1,
wherein said apparatus includes a plurality of units of said light irradiation module and a plurality of units of said light detection module and those modules are disposed in an array pattern respectively.

5. The biological optical measuring apparatus according to claim 1,
wherein said apparatus further includes a first module in which a plurality of units of said light irradiation module and a plurality of units of said light detection module are disposed in an array pattern respectively,
wherein said apparatus further includes a second module in which a plurality of units of said light irradiation module and a plurality of units of said light detection module are disposed in an array pattern respectively, and
wherein said first and second modules are disposed so as to put said examinee therebetween.

6. The biological optical measuring apparatus according to claim 1,
wherein a cerebral function analyzer is provided outside said apparatus, and
wherein a signal detected by said apparatus is transmitted wirelessly to said cerebral function analyzer.

7. A light detection module employed for a biological optical measuring apparatus, comprising:
a first circuit having a high voltage power supply;
a second circuit having a signal amplifying circuit; and
a light detection element for detecting a light,
wherein said first and second circuits and said light detection element are disposed in three dimensions in the order of said first circuit, said second circuit, and said light detection element or in the order of said second circuit, said first circuit, and said light detection element,
wherein said first and second circuits are enclosed by a housing material,
wherein said housing material has a hole for guiding an external light to said light detection element, and
wherein a terminal for supplying a power and a terminal for guiding a signal detected by said light detection element to external are exposed outside said housing material.

8. The light detection module according to claim 7,
wherein a test terminal for measuring an insulating strength is exposed outside said housing material.
